(19) United States
(12) Patent Application Publication
(10) Pub. No.: US 2008/0110363 A1
(43) Pub. Date: May 15, 2008

(54) Physisorption-based microcontact printing process capable of controlling film thickness

(75) Inventors: Jung-Wei John Cheng, Chia-Yi (TW); Jeng-Rong Ho, Chia-Yi (TW); Wei-Hsuan Hung, Chia-Yi (TW); Jia-De Jhu, Taipei County (TW); Hsiang-Chiu Wu, Chia-Yi (TW); Wei-Chun Lin, Pingtung County (TW); Wei-Ben Wang, Chia-Yi (TW)

Correspondence Address: BACON & THOMAS, PLLC, 625 SLATERS LANE, FOURTH FLOOR, ALEXANDRIA, VA, 22314, US

(73) Assignee: NATIONAL CHUNG CHENG UNIVERSITY, CHIA-YI (TW)

(21) Appl. No.: 11/598,717

(22) Filed: Nov. 14, 2006

(51) Int. Cl. B41M 1/26

(52) U.S. Cl. 101/483

(57) ABSTRACT

The disclosed is a physisorption-based microcontact printing process capable of controlling film thickness, primarily for creating patterns of thin film of organic molecules in micron and submicron scales, comprising an inking phase, a printing phase, and a demolding phase. The inking phase is combined with a thin-film growth approach, wherein the thin-film approach enables growth of an organic thin film with desired thickness onto a stamp, effectively controls the thickness of the pattern of the organic thin film transferred in the next printing phase. The demolding phase enables proper control of the temperature of and the printing pressure upon the transferred thin-film pattern to control the quality of surface roughness and residual internal stress in the printed pattern.

### BACKGROUND OF THE INVENTION

1. Field of the Invention

This invention discloses a physisorption-based microcontact printing process capable of controlling film thickness, primarily for creating patterned thin films of organic molecules in micron and submicron scales. This invention employs the thin-film growth technology and the microcontact printing technology together to improve the deficiency that the conventional microcontact printing process fails to control the thickness of the transferred pattern. At the final phase of the microcontact printing process, when the stamp is going to disengage from the transferred pattern, an additional demolding step is applied to effectively control the quality of the transferred pattern. Possible applications of this invention include, but not limited to, fabrication of electronic, optoelectronic, and micro electro-mechanical systems, and elements of nanotechnology.

2. Description of the Related Art

The relevant prior art is listed below:
Kumar, A and Whitesides, G. M., “Features of gold having micrometer to centimeter dimensions can be formed through a combination of stamping with an elastomeric stamp and an alkanethiol “ink” followed by chemical etching,” Appl. Phys. Lett., vol. 63, pp. 2002-2004, 1993 (hereinafter referred to as “KW93”)
Kim, C.; Burrows, P. E.; Forrest, S. R.; “Micropatterning of organic electronic devices by cold-welding,” Science, vol. 288, pp. 831-833, 2000 (hereinafter referred to as “KBF00”)
Kim, C.; Shtein, M.; and Forrest, S. R., “Nanolithography based on patterned metal transfer and its application to organic electronic devices,” Appl. Phys. Lett., vol. 80, pp. 4051-4053, 2002 (hereinafter referred to as “KSF02”)
Granlund, T.; Nyberg, T.; Roman, L. S.; Svensson, M.; and Inganas, O., “Patterning of polymer light-emitting diodes with soft lithography,” Adv. Mater., vol. 12, pp. 269-273, 2000 (hereinafter referred to as “GNR00”)
Lee, T.-W.; Zaumseil, J.; Bao, Z.; Hsu, J. W. P.; Rogers, J. A., “Organic light-emitting diodes formed by soft contact lamination,” PNAS (Proc. Of the Nat'l Academy of Sciences of USA), vol. 101, pp. 429-433, 2004 (hereinafter referred to as “LZB04”)
Jacobs, H. O.; Whitesides, G. M.; “Submicrometer patterning of charge in thin-film electrets,” Science, vol. 291, pp. 1763-1766, 2001 (hereinafter referred to as “JW01”)
Michaeli, W.; Lauterback, M.; “Quality control for the packing pressure phase—with pmT control,” Adv. Polym. Tech., vol. 9, pp. 337-343, 1989 (hereinafter referred to as “ML89”)
Donzel, C.; Geissler, M.; Bernard, A.; Wolf, H.; Michel, B.; Hilborn, J.; Delamarche, E.; “Hydrophilic poly(dimethylsiloxane) stamps for microcontact printing,” Adv. Mater., vol. 13, pp. 1164-1167, 2001 (hereinafter referred to as “DGB01”)
Odom, T. W.; Thalladi, V. R.; Love, J. C.; Whitesides, G. M.; “Generation of 30-50 nm structures using easily fabricated, composite PDMS masks,” J. Am. Chem. Soc., vol. 124, pp. 12112-12113, 2002 (hereinafter referred to as “OTL02”)

The art of microcontact printing (μCP) was first disclosed in a technical paper published by A. Kumar and G. M. Whitesides in 1993 as indicated in KW93. Similar to a regular printing process, μCP is operated by that a stamp with a designed pattern is used to print ink molecules onto a substrate to enable formation of the designed pattern on the substrate. Different from the regular printing process, μCP can transfer patterns in micron or nanometer scale because it employs a stamp which raised surfaces are made of materials with very low surface free energy, e.g. PDMS, poly(dimethylsiloxane), and carefully selects ink and substrate such that the ink molecules are favorably adsorbed chemically or physically onto the substrate when they are brought into contact with the substrate.

FIGS. 1a-1d illustrate the chemisorption-based μCP originally proposed in the paper in 1993 as indicated in KW93. It starts with preparation of a Si substrate 102 coated with a gold thin film 104, as shown in FIG. 1a, and a PDMS stamp 106 having a desired pattern on its surface and coated with an ink-molecule layer 108, specifically, alkanethiol, as shown in FIG. 1b. Inking the PDMS stamp was achieved by either pressing the stamp on an ink pad prepared by moistening a piece of lint-free paper with an alkanethiol solution or by pouring the alkanethiol solution directly onto the stamp. The inked stamp is then brought into contact with the gold-plated substrate, as shown in FIG. 1c, and the alkanethiol ink molecules and the gold atoms together generate a self-assembled monolayer through covalent bonding. After removal of the PDMS stamp, the patterned gold-alkanethiol self-assembled monolayer 110 is printed onto the gold-plated substrate, as shown in FIG. 1d.

Evidently, the chemisorption-based μCP is constrained by the limited choices of the combinations of the ink and the substrate. Under such circumstance, the application scope of such μCP is greatly limited. In light of this, several physisorption-based μCPs were proposed, including a thermal assist approach indicated in GNR00, a cold-welding approach indicated in KBF00 and KSF02, a van der Waals force approach indicated in LZB04, and an electrical charge approach indicated in JW01. Although the property of minimally printable pattern size could merely reach the micron or submicron scale, failing to match that of the chemisorption-based μCP in the nanometer scale, these physisorption-based μCP processes effectively extend the application scope of the μCP. FIGS. 2a-5d illustrate the ideas and steps of these physisorption-based μCP processes.

FIGS. 2a-2d illustrate the idea of the μCP based on the thermal assist approach, which procedure is similar to that of the original chemisorption-based μCP. According to GNR00, a glass substrate 202 coated with indium tin oxide (ITO) or gold 204, as shown in FIG. 2a, and a PDMS stamp 206, having a designed pattern, dip-coated with an ink solution 208 made of PEDTO-PSS, poly(3,4-ethylene dioxythiophene)-poly(styrene sulfonate), as shown in FIG. 2b, are prepared first. FIG. 2c shows that the coated PDMS stamp is brought into contact with the substrate at an elevated temperature under an external heat source 212. The PEDOT-PSS ink with the designed pattern is transferred onto the substrate after removal of the PDMS stamp, as shown in FIG. 2d.

FIGS. 3a-3d illustrate the μCP based on the cold-welding approach. First, a thin film 304 of a metal is plated on a substrate 302, as shown in FIG. 3a. Next, a thin film 308 of the same metal is plated on the surface of a stamp 306 having a desired pattern, as shown in FIG. 3b. An adhesion reduction layer 307 is disposed between the stamp 306 and the film 308 to facilitate the pattern transfer. The stamp is pressed with high pressure 314 against the substrate 302 to enable cold-welding action between the two films 304 and 308, as shown in FIG. 3c. After removal of the stamp 306, a cold-welded metallic film 310 with the desired pattern is formed on the substrate, as shown in FIG. 3d. According to KSF02, in order to withstand the high pressure required by the cold-welding, each of the substrate and the stamp was made of Si.

The μCP based on van der Waals force approach was proposed and named soft contact lamination method in a paper indicated in LZB04. It was used to create the cathode of an organic light-emitting diode (LED). According to LZB04, FIG. 4a shows a glass substrate 402 disposed with an ITO anode 403 and an organic electroluminescent layer 404. FIG. 4b shows a flat PDMS stamp 406 coated with a metallic pattern 408 made of titanium or gold. When the PDMS stamp is in contact with the substrate, the metallic pattern 408 is combined with the organic electro-luminescent layer 404 by means of the van der Waals force, as shown in FIG. 4c. When the metallic pattern 408 on the stamp is regarded as the cathode, an organic LED array is then created without removing the PDMS stamp.

FIGS. 5a-5d illustrate the μCP based on the electrical charge approach. A conductive substrate 502 coated with a thin film 504 made of an electret material, such as PMMA, poly(methyl methacrylate), is prepared first as shown in FIG. 5a. Next, a PDMS stamp 506 having a desired pattern is coated with a metallic film 508, as shown in FIG. 5b. The PDMS stamp is brought into contact with the conductive substrate, the metallic film 508 and the conductive substrate 502 are used as electrodes, and a pulsed voltage source 516 is applied as shown in FIG. 5c. When the PDMS stamp and the pulsed voltage source are removed, a pattern 510 formed by the electric charges gathered on the electret film 504 remains, as shown in FIG. 5d.

As indicated above, the physisorption-based μCPs, even the μCP as a whole, are still in their infancy and many deficiencies remain. For example, three of the aforementioned four physisorption-based approaches, namely, the cold-welding, van der Waals force, and electrical charge approaches, are not applicable to the organic materials. Although the thermal assist approach is applicable to the organic materials, it is not capable of controlling the thickness of the transferred pattern.

This invention presents a physisorption-based μCP designed for organic materials and capable of thickness control. One of its innovations is the proposal of an additional process step, called the demolding phase, to the existing μCP practices for better quality control of printed patterns. In the demolding phase, the printing pressure and temperature are decreased in a coordinated manner according to the P-V-T (Pressure-specific Volume-Temperature) rheological property of the ink molecules to achieve better morphology and reduced residual internal stress in the printed patterns. The idea of the demolding phase is borrowed from the P-V-T control practice in the injection molding process indicated in ML89, which is briefly described in the following.

FIG. 6 illustrates the P-V-T rheological data of a polymer and indicates the ideal evolution of the P-V-T rheological behavior of the polymer during the injection molding process. After the polymer fills the mold cavity, the section from Point A to point B represents the P-V-T rheological behavior while the polymer is under packing. Since the packing time is very short, usually between seconds and shorter than one second, the temperature of the polymer is deemed constant. At the point B, when the process is switched from the packing phase to the holding phase, the pressure in the mold cavity is held constant. When the temperature of the polymer in the mold cavity starts to decrease, the volume of the polymer reduces and more polymers are packed into the mold cavity to keep the pressure inside the mold cavity. At the point C, the process is switched again for maintaining constant volume of the polymer. The pressure inside the mold cavity must now be reduced according the P-V-T rheological data along with the temperature decrease of the polymer. At the point D, it indicates the end of the demolding phase when the polymer becomes solidified.

### SUMMARY OF THE INVENTION

The primary objective of the present invention is to provide a physisorption-based microcontact printing process capable of controlling film thickness primarily for creating patterns of organic thin films in micron and submicron scales, which effectively controls the thickness of the printed organic patterns.

The secondary objective of the present invention is to provide a physisorption-based microcontact printing process capable of controlling film thickness primarily for creating patterns of organic thin films in micron and submicron scales, which controls the quality of surface roughness and residual internal stress in the printed organic patterns.

The foregoing objectives of the present invention are attained by the process including an inking phase, a printing phase, and a demolding phase as summarized below.

Conventional practices for inking the printing stamp include imprinting, dip-coating, or spraying. These methods do not offer effective control in the amount of ink molecules applied, let alone the thickness control of the printed pattern. To improve such deficiency of thickness control, the present invention proposes an inking phase involving a thin-film growth, through which a thin-film of ink molecules with the desired thickness is deposited on the printing stamp, indirectly achieving thickness control of the printed pattern. The inking phase of the present invention includes two steps of surface wetting and thin-film growth.

On the one hand, the μCP is to print the ink molecules on the stamp onto the substrate, so the stamp is made of a material with very low surface free energy to reduce the affinity between the ink molecules and stamp, thus facilitating the transfer printing of the ink molecules. On the other hand, an effective thin-film growth requires high affinity between the molecules of the thin-film and the surface of the substrate to enable deposition of a high-quality homogeneous thin film with a smooth surface. The first step of the inking phase of the present invention, i.e. surface wetting, is to reconcile the conflict between the requirement of a successful transfer printing and that of a high-quality thin-film growth. Thus, to succeed in the surface wetting, it requires two conditions as follows: effective enhancement of the affinity between the stamp surface and the ink molecules and such enhancement must be impermanent. There are two feasible methods of the surface wetting as follows. First, the stamp is coated with a wetting layer made of highly evaporative solvent properly selected to effectively enhance the affinity between the stamp surface and the ink molecules and such enhancement is impermanent because of the high evaporation rate of the solvent. Second, the stamp is done with some special surface treatment. One possible treatment is the O₂ plasma treatment. According to DGB01, the PDMS stamp with low surface free energy can be treated by O₂ plasma to generate a wetting layer composed of hydroxyl, carboxyl, or peroxide to enhance the surface free energy of the PDMS stamp and such enhancement of the surface free energy holds for about one day only.

After arrangement and operation of the effective surface wetting, the second step, thin-film growth, is proceeded to enable the growth of a thin film of ink molecules with a desired thickness onto the stamp. Any thin-film technique can be considered as a candidate for the step of the thin-film growth, e.g. spin coating and blade coating.

The above-mentioned inking phase involving the thin-film growth provides an effective method for thickness control of the ink molecules on the surface of the stamp, indirectly achieving the purpose of controlling the thickness of the transferred pattern through μCP. Furthermore, in the aforementioned inking phase, a pre-patterned or flat stamp can be used. While the flat stamp is used, the desired pattern can be formed by a follow-up patterning using a proper patterning technique, such as laser ablation.

In the printing phase, similar to that of the thermal assist μCP, the substrate and the stamp are not only heated to enhance the temperature thereof but also applied with an adequate pressure. The enhancement of the temperature of the substrate and the stamp improves not only the wetting condition between the ink molecules and the substrate but the adhesive condition therebetween; the applied pressure increases the effective contact area between the thin film of ink molecules and the substrate to improve the adhesion to each other; and both together successfully transfer the ink molecules to the substrate.

Because the stamp is commonly made of flexible PDMS, to securely keep the pattern on the surface of the stamp under a proper pressure from deformation, a hybrid stamp composed of a rigid stamp covered thereon with the thin film of PDMS as indicated in OTL02 can be adopted.

The currently available μCP technology did not particularly elaborate on the demolding phase but merely mentioned that the stamp is removed to complete the whole μCP after a given time of printing contact. For better surface smoothness and reduced residual internal stress in the transferred pattern, the present invention proposes an additional demolding phase where the removal of the stamp is a precisely controlled process rather than a simple removal. In the demolding phase, as the temperature of the transferred ink molecules decreases, the pressure applied to them is also lowered according to the P-V-T rheological data of the ink molecules in order to give rise to a transferred pattern with reduced surface roughness and residual internal stress.

### BRIEF DESCRIPTION OF THE DRAWINGS

FIGS. 1a-1d are cross-sectional views of the conventional chemisorption-based μCP.

FIGS. 2a-2d are cross-sectional views of the conventional μCP based on the thermal assist approach.

FIGS. 3a-3d are cross-sectional views of the conventional μCP based on the cold-welding approach.

FIGS. 4a-4d are cross-sectional views of the conventional μCP based on the van der Waals force approach.

FIGS. 5a-5d are cross-sectional views of the conventional μCP based on the electrical charge approach.

FIG. 6 is a chart of the prior art, illustrating the P-V-T rheological data of a polymer and indicating the ideal evolution of the P-V-T rheological behavior of the polymer during the injection molding process.

FIGS. 7a-7c are cross-sectional views of a preferred embodiment of the present invention, illustrating the inking phase when the pre-patterned stamp is used.

FIGS. 7d-7g are cross-sectional views of the preferred embodiment of the present invention, illustrating the inking phase when the flat stamp is used and the pattern is formed in the thin film of the ink molecules via a proper patterning technique.

FIGS. 8a-8b are cross-sectional views of the preferred embodiment of the present invention, illustrating the printing phase when the pre-patterned stamp and the flat stamp are used, respectively.

FIG. 9 is a cross-sectional view of the preferred embodiment of the present invention, illustrating the transferred pattern with desired thickness onto the substrate after the demolding phase.

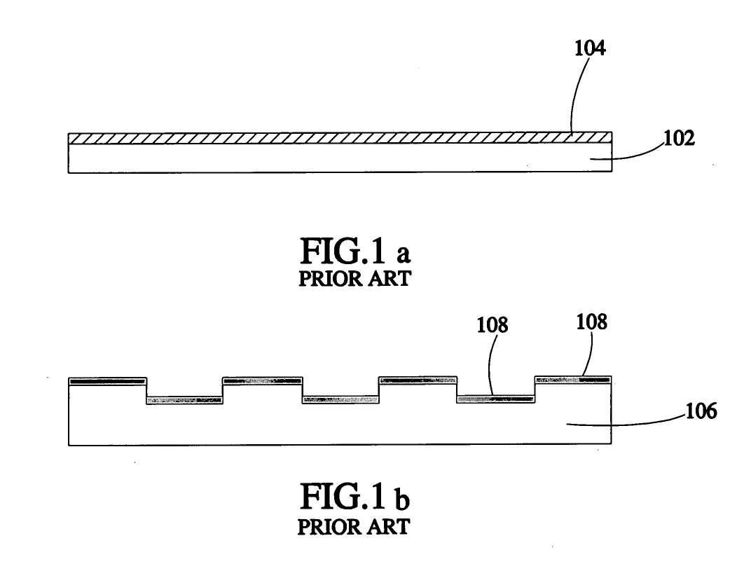

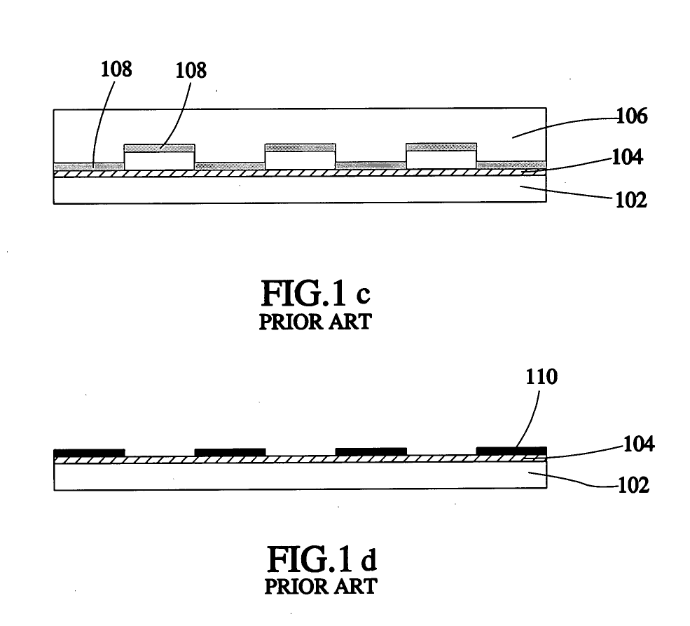

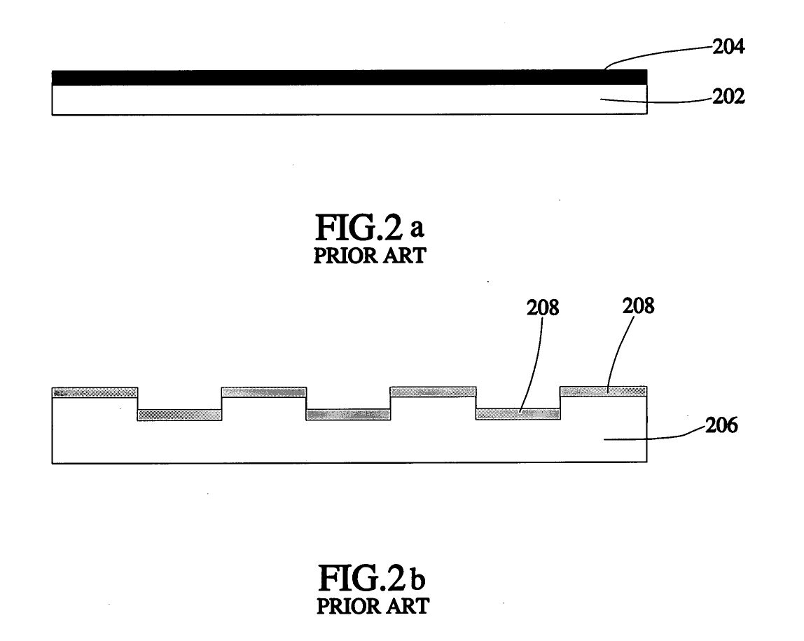

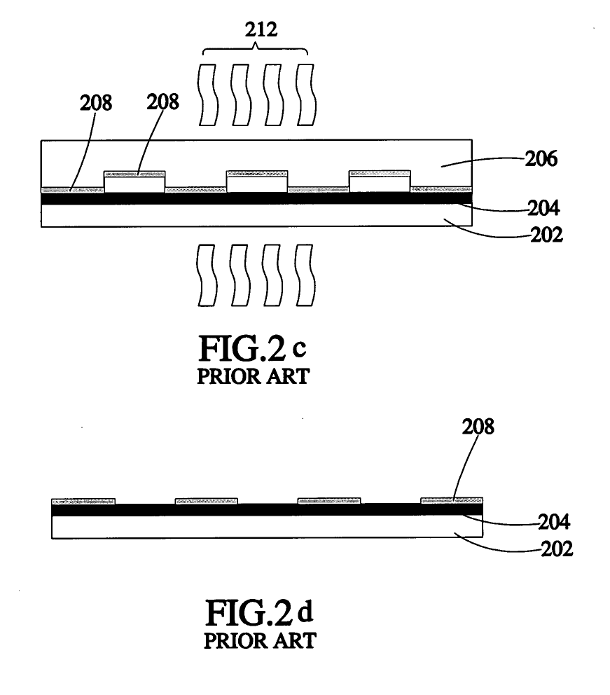

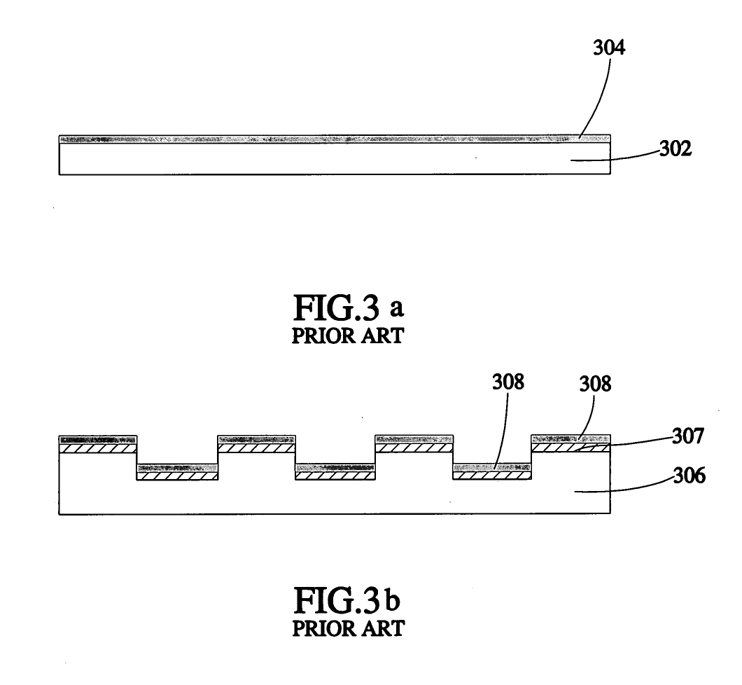

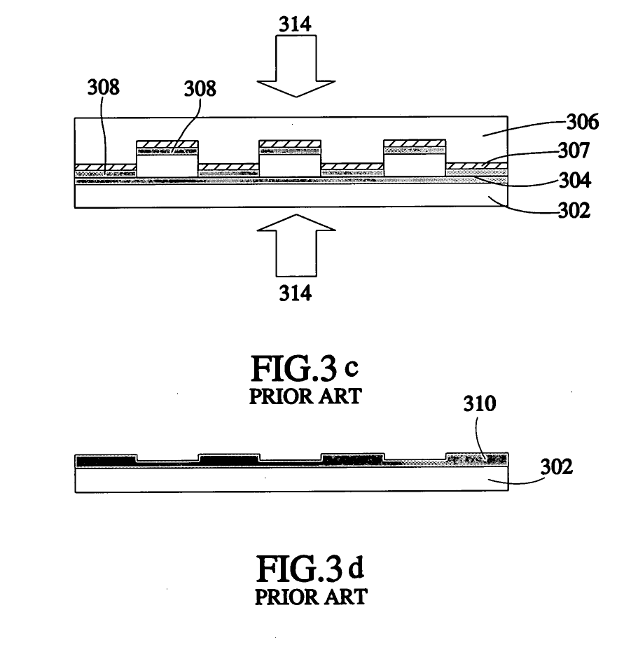

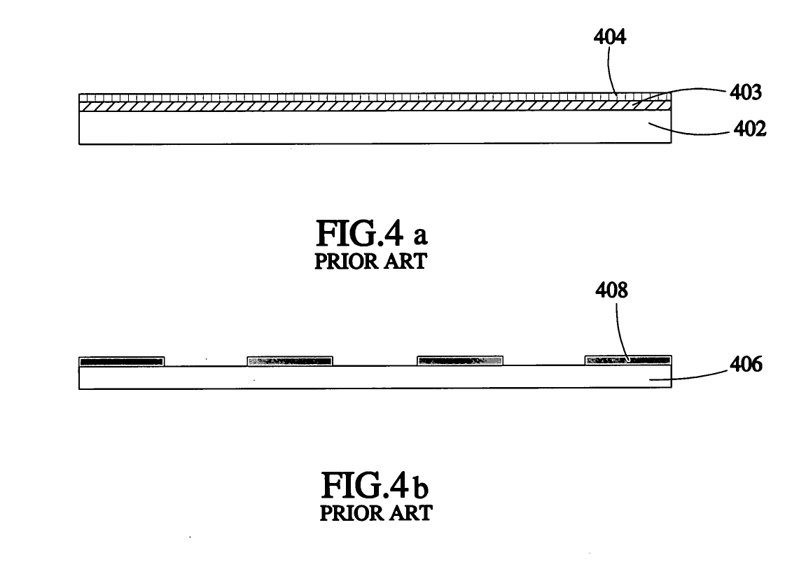

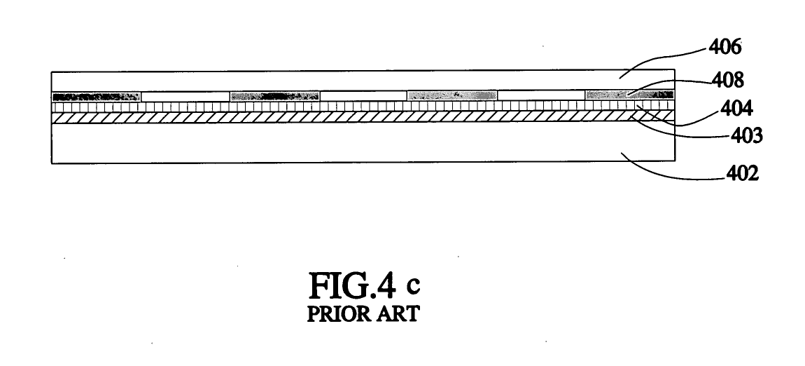

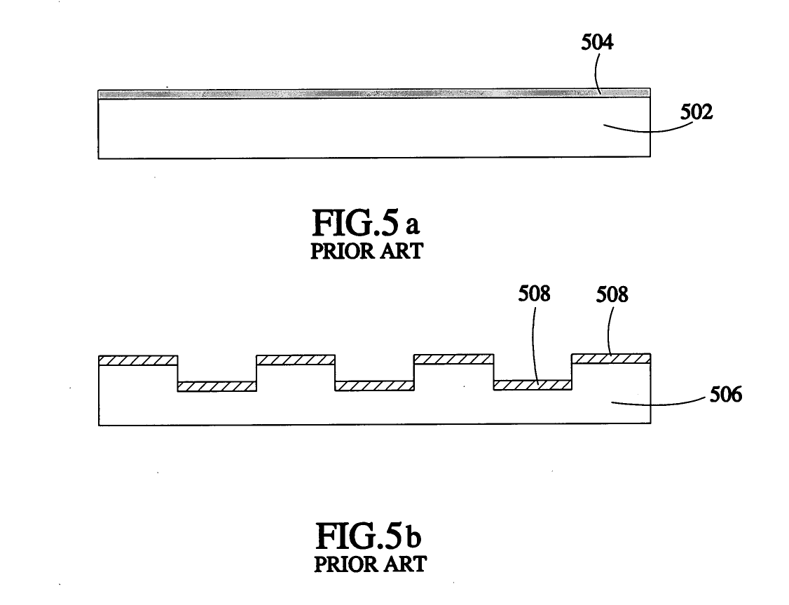

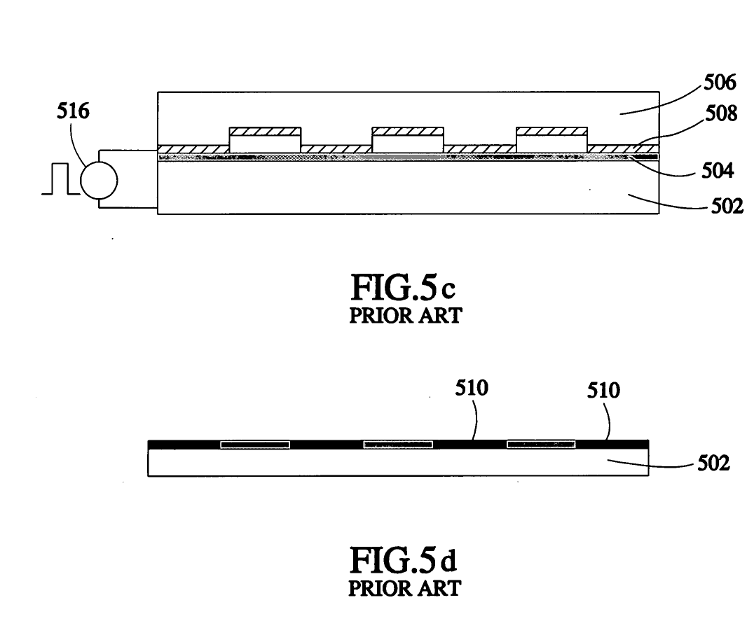

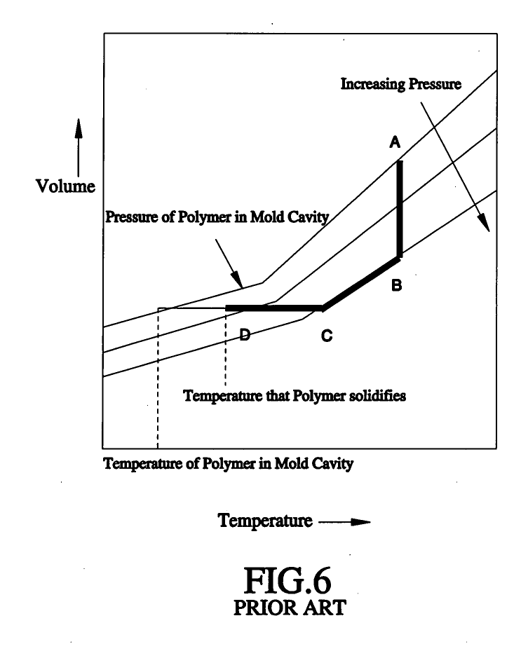

### DETAILED DESCRIPTION OF PREFERRED EMBODIMENTS

The present invention proposes a physisorption-based microcontact printing process capable of controlling film thickness, including three phases of inking, printing, and demolding. The inking phase further has two steps of surface wetting and thin-film growth. The surface wetting step is optional, depending on whether it is necessary. When it is necessary, a wetting layer is deposited onto a stamp to facilitate successful growth of a thin film of the ink molecules on the stamp in the next thin-film growth step. In the following preferred embodiments, the surface-wetting step is required.

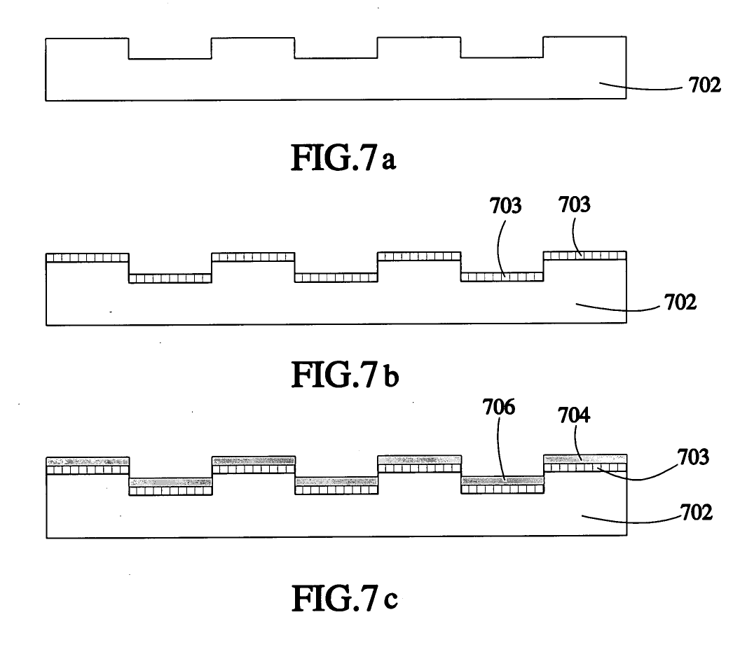

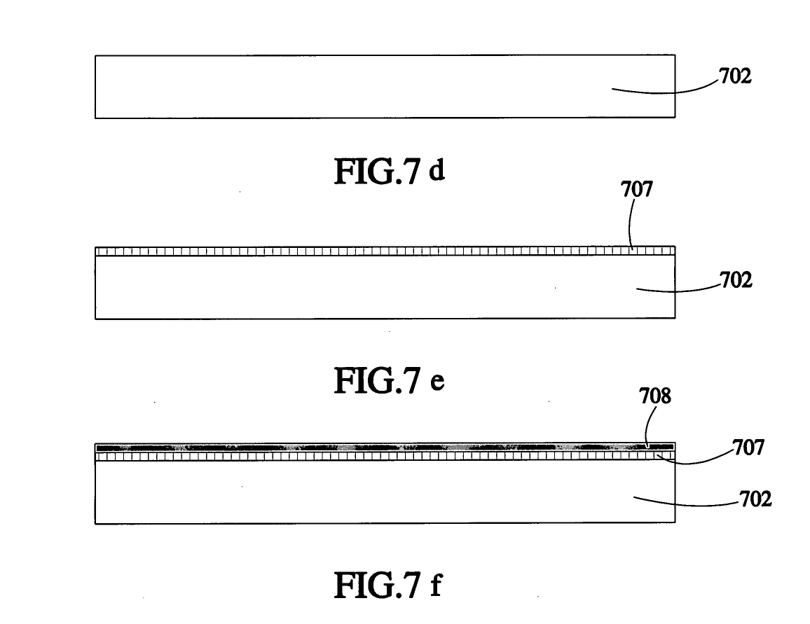

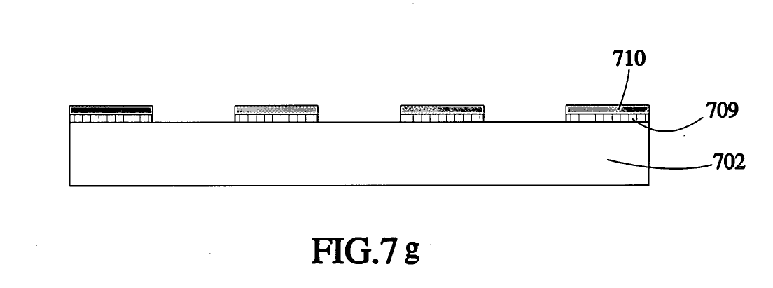

FIG. 7a shows a pre-patterned stamp 702 made of a material having very low surface free energy, such as PDMS. Referring to FIG. 7b, a wetting layer 703 is formed on a surface of the stamp 702 after surface wetting. The wetting layer 703 can be made of highly evaporative solvent, like toluene, or of highly reactive function group generated after surface treatment of the stamp 702. For example, a wetting layer made of hydroxyl, carboxyl, or peroxide can be generated after O₂ plasma treatment of the surface of the PDMS stamp. FIG. 7c shows that a thin film 704 of ink molecules has been deposited on the top of the pre-patterned stamp using an appropriate thin-film deposition method. One simplest possible thin-film growth approach is the spin coating. Note that the ink molecules may be deposited not only on plateaus 704 but also on valleys 706 of the stamp 702. The ink molecules in the valleys 706 do not interfere with the next printing step as long as the valleys 706 are deep enough. However, the valleys 706 should not be too deep because the plateaus 704 of the stamp 702 will collapse due to the mutual attraction between the material molecules of the stamp or due to an excessive pressing force on the stamp during the next printing phase. Suitable valley depth is an experimentally determined parameter.

Sometimes, the actual operation is different from the above. It is likely to ink a flat stamp and then apply a suitable patterning approach on the ink molecules to generate a pattern. When a flat stamp (FIG. 7d) is used, a wetting layer 707 (FIG. 7e) and a thin film 708 of ink molecules (FIG. 7f) are formed on the stamp respectively, as in the case of pre-patterned stamp. A suitable patterning approach is then applied to the thin film 708 to generate a desired pattern 710 (FIG. 7g). In this embodiment, any suitable patterning approach, e.g. the laser ablation, is applicable.

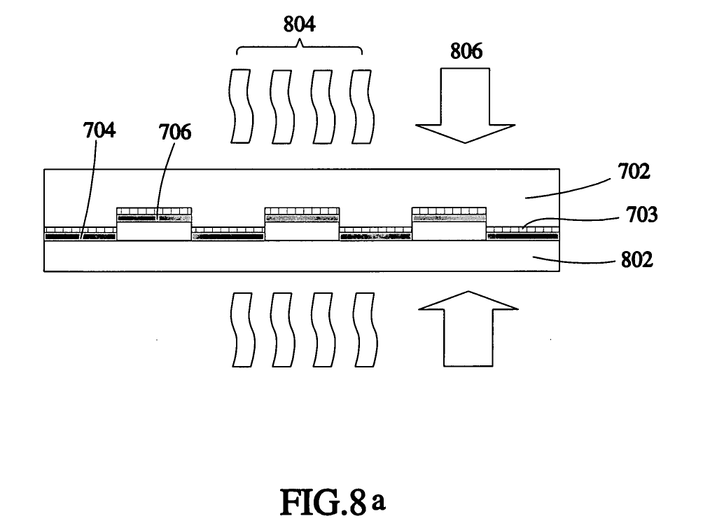

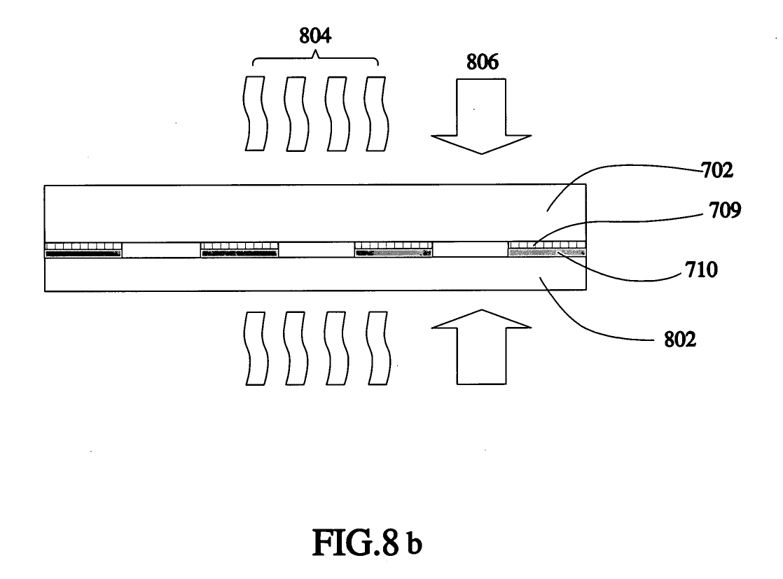

Referring to FIGS. 8a-8b, in the printing phase, the inked stamp 702 is placed upon a substrate 802 with externally applied heat source 804 and printing pressure 806. The external heat source 804 raises the temperature of the substrate or the stamp to help improve the wetting condition and promote adhesion between the ink molecules and the substrate 802. The raised temperature of the substrate or the stamp can be higher or lower than the glass transition temperature of the ink molecules. The external printing pressure 806 increases the contact area between the thin film 704 (710) and the substrate 802, consequently enhancing the adhesion between them. In the printing phase, adjusting the temperature and printing pressure of the substrate or the stamp can optimize the transfer potency of the thin film 704 (710). It is worth noting that although the wetting layer 703 (709) is depicted in FIG. 8a (8b), it is highly probable that the wetting layer may already disappear at the initiation of the printing phase because of its short existence as explained before. Even if the wetting layer still exists, it can be sure that its effect will be insignificant so that its existence will not interfere with the successful printing of the thin film 704 (710).

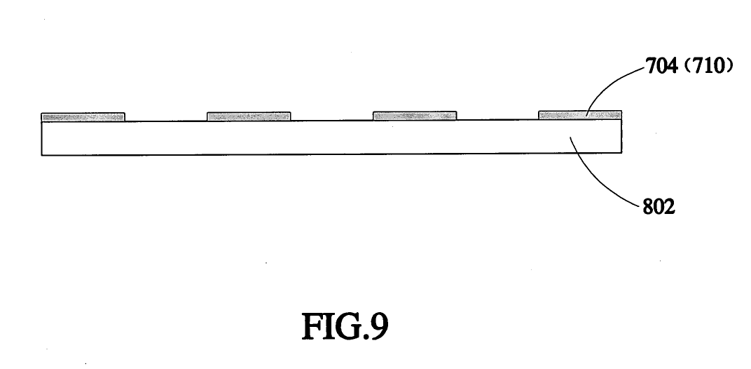

The third phase, i.e. the demolding phase, of the μCP of the present invention begins right after the printing phase. Switching from the printing phase to the demolding phase can occur after a given period of printing time or at a given temperature or at a given printing pressure or at any combination of these conditions. In order to effectively reduce the surface roughness and the residual internal stress in the transferred pattern 704 or 710, as shown in FIG. 9, during the demolding phase, as the temperature of the transferred pattern decreases, the printing pressure of the stamp should be lowered according to the P-V-T rheological data of the ink molecules. Illustrating the P-V-T rheological data of general organic molecules, FIG. 6 is taken to help elaborate on the operation principle of the demolding phase of the present invention. Each curve in FIG. 6 indicates that the volume V of the organic molecule shrinks as its temperature T lowers under a constant pressure P. The control of the temperature and the pressure in the demolding phase enables the temperature T and the pressure P to pass through the P-V-T curves along the straight line defined between points C and D in FIG. 6, such that the thin film composed of the organic molecules exhibits uniform shrinkage and least residual internal stress while the thin film becomes hardened. Alternatively, when shrinkage uniformity and residual internal stress are not major concerns, the stamp can be removed without the aforementioned demolding phase. In other words, the stamp can simply remain on the substrate without any temperature and pressure control and then be removed when the thin film becomes hardened after the printing phase.

Although the present invention has been described with respect to a specific preferred embodiment thereof, it is no way limited to the details of the illustrated structures and changes and modifications may be made within the scope of the appended claims.

What is claimed is:

1. A physisorption-based microcontact printing process capable of controlling film thickness, comprising an inking phase and a printing phase, wherein desired thickness of a thin film is controllable in said inking phase.

2. The process as defined in claim 1, wherein said inking phase includes a step of disposing a thin film of ink molecules with desired thickness on a printing stamp.

3. The process as defined in claim 2, wherein disposing said thin film is done by either of all thin-film growth approaches.

4. The process as defined in claim 2 or 3, wherein said inking phase further includes a step of bringing forth a wetting layer capable of temporary surface wetting onto said printing stamp before disposing said thin film through the thin-film growth approach for temporarily enhancing affinity between a surface of said stamp and said ink molecules.

5. The process as defined in claim 2, wherein said printing stamp is either a pre-patterned stamp or a flat stamp.

6. The process as defined in claim 5, wherein a step of pattern generation can follow the step of disposing said thin film on said stamp while said printing stamp is a flat stamp.

7. The process as defined in claim 1, wherein said printing phase includes a step of printing a pre-patterned stamp with a thin-film of ink molecules or a flat stamp disposed thereon with a patterned thin film of ink molecules onto a substrate.

8. The process as defined in claim 7, wherein said printing phase further includes a step of applying an external heat source to enhance the temperature of said substrate or said stamp or applying an external printing pressure to enhance the chance of successful printing.

9. The process as defined in claim 7 or 8, wherein the enhanced temperature of and the printing pressure upon said substrate or said stamp are adjustable to enable said thin film to be optimally transferred onto said substrate.

10. The process as defined in claim 1 further comprises a demolding phase following the printing phase.

11. The process as defined in claim 10, wherein switching from the printing phase to the demolding phase occurs after a given period of printing time or at a given temperature or at a given printing pressure or at any combination of these conditions.

12. The process as defined in claim 10, wherein in said demolding phase, according to pressure-specific volume-temperature (P-V-T) rheological behaviors of the ink molecules, the externally applied printing pressure and the temperature of said substrate or stamp are synchronically reduced to enable said ink molecules to keep constant volume while cooled, further enabling said transferred pattern to have preferable surface smoothness and evenness and reduced residual internal stress.

13. The process as defined in claim 7, wherein said printing stamp is removed from said substrate after a surface of said thin film becomes hardened in the printing phase.
